(19) United States
(12) Patent Application Publication
(10) Pub. No.: US 2008/0099280 A1
(43) Pub. Date: May 1, 2008

(54) APPARATUS FOR THE LUBRICATION OF A ROLLER BEARING IN A WIND ENERGY PLANT

(75) Inventors: Uwe Kroh, Rostock (DE); Eberhard Voss, Jornstrof (DE)

Correspondence Address: VIDAS, ARRETT & STEINKRAUS, P.A., SUITE 400, 6640 SHADY OAK ROAD, EDEN PRAIRIE, MN, 55344, US

(73) Assignee: Nordex Energy GmbH, Norderstedt (DE)

(21) Appl. No.: 11/775,978

(22) Filed: Jul. 11, 2007

(30) Foreign Application Priority Data
Oct. 27, 2006 (DE) 10 2006 050 765.7

(51) Int. Cl. F16N 1/00

(52) U.S. Cl. 184/4

(57) ABSTRACT

An apparatus for the lubrication of a roller bearing of a wind energy plant, with a container for lubricant having a chamber, which is divided into a chamber portion for fresh lubricant and a chamber portion for used lubricant through a movable piston, wherein each chamber portion is connected via a line to a lubricant channel passing through the roller bearing.

### CROSS-REFERENCE TO RELATED APPLICATIONS

Not applicable.

### STATEMENT REGARDING FEDERALLY SPONSORED RESEARCH

Not applicable.

### BACKGROUND OF THE INVENTION

The present invention is related to an apparatus for the lubrication of a roller bearing in a wind energy plant.

From EP 1 423 606 B1, the entire contents of which is incorporated herein by reference, a pitch adjustment equipment of a rotor blade with a perimetral lubricant chamber is known. The lubricant chamber embraces a gearwheel, via which the pitch for the rotor blade is shifted. The known lubricant chamber circulates around the bearing and constitutes a sufficiently large volume range for the roller bodies and the toothing. In this, the lubricant chamber is a chamber put on to the roller bearing.

From EP 1 273 814 A1, the entire contents of which is incorporated herein by reference, an apparatus for the lubrication of a roller bearing is known, in which a lubricant reservoir is put on to the outer ring of a roller bearing. Via a lubricant channel, the lubricant is lead to the roller body, from where it then spreads. The lubricant is collected in a lubricant container which is also attached to the outer ring.

The present invention is based on the objective to provide an apparatus for the lubrication of the roller bearing for a roller bearing in a wind energy plant, which permits to supply lubricant to the roller bearing with simple means.

### BRIEF SUMMARY OF THE INVENTION

The apparatus according to the present invention serves for the lubrication of a roller bearing in a wind energy plant. Such a roller bearing may be the pitch adjustment between rotor blade root and rotor blade hub, for instance. In principle however, it may also be a roller bearing like the azimuth bearing, for instance. The apparatus according to the present invention has a container for lubricants, which has a chamber. The chamber in the container is subdivided by a movably bearing-mounted piston into one chamber portion for fresh lubricants and another chamber portion for used lubricants. Each one of the chamber portions is connected via at least one line with at least one lubricant channel leading through the roller bearing. Via the supply line, the transportation of fresh lubricant into the roller bearing takes place, where is flows out again after having passed the lubricant channel and is lead back into the chamber portion for the used lubricant via a line. In this, the lubricant channel in the roller bearing can also comprise the running track for the roller bodies. A particular advantage in the realisation according to the present invention is that a common container for fresh and used lubricant is provided.

In a preferred extension of the realisation according to the present invention, the piston in the chamber is pretensioned through a spring means, in order to reduce the volume of the chamber portion for the fresh lubricant and to increase the volume of the chamber portion for the used lubricant. Thus, the spring means has the effect that fresh lubricant is pressed into the roller bearing and used lubricant is sucked out from the roller bearing. In addition, it is preset by the floating piston that a volume of lubricant introduced into the roller bearing is also essentially taken out again.

In a preferred extension of the apparatus according to the present invention, the lines leading from the chamber portion for fresh lubricant to the roller bearing and/or the corresponding back line from the roller bearing into the chamber portion for used lubricant are each at a time equipped with a stop valve. Closing this line interrupts the flow of lubricant into the bearing and the flow of lubricant out of the bearing, respectively. Through this, inlet and outlet can be closed when the lubricant container is changed, for instance. Also, for instance the amount of lubricant entering or lead through, respectively, can be adjusted when other maintenance works on the bearing are made.

In order to be able to detect more simply how far the lubricant has already passed through, an indicating means can be provided on the container, which indicates the position of the piston in the container.

In an also possible variant, a pump for lubricant can be provided in at least one of the lines between container and roller bearing, which conveys the lubricant through the roller bearing.

In a preferred extension of the apparatus according to the present invention, the container is provided with a closable opening, which is arranged in the region of the chamber portion for fresh lubricant, in order to connect the same with the surroundings at minimum volume of that chamber portion. In order to fill up fresh lubricant, fresh lubricant is supplied via the fill-in opening when the piston has advanced widely. Via a corresponding opening for the used lubricant, used lubricant can preferably be let off from the container. Even for this purpose, the opening is arranged near to the end of the container.

In order to supply the roller bearing uniformly with lubricant, the container can be connected to plural lines, which are each one at a time connected to an opening of one or plural lubricant channels passing through the roller bearing. In this, it is possible that the container itself is connected to plural lines or that the container is connected to a main line, from which several stub lines branch off which then each at a time lead to one opening of the lubricant channel.

### BRIEF DESCRIPTION OF THE SEVERAL VIEWS OF THE DRAWINGS

The apparatus according to the present invention is explained in more detail by means of an example of its realisation in the following.

FIG. 1 shows a schematic view of the lubricant container according to the present invention, and

FIG. 2 shows a schematic view regarding the connection of the lubricant container to a roller bearing.

### DETAILED DESCRIPTION OF THE INVENTION

While this invention may be embodied in many different forms, there are described in detail herein a specific preferred embodiment of the invention. This description is an exemplification of the principles of the invention and is not intended to limit the invention to the particular embodiment illustrated

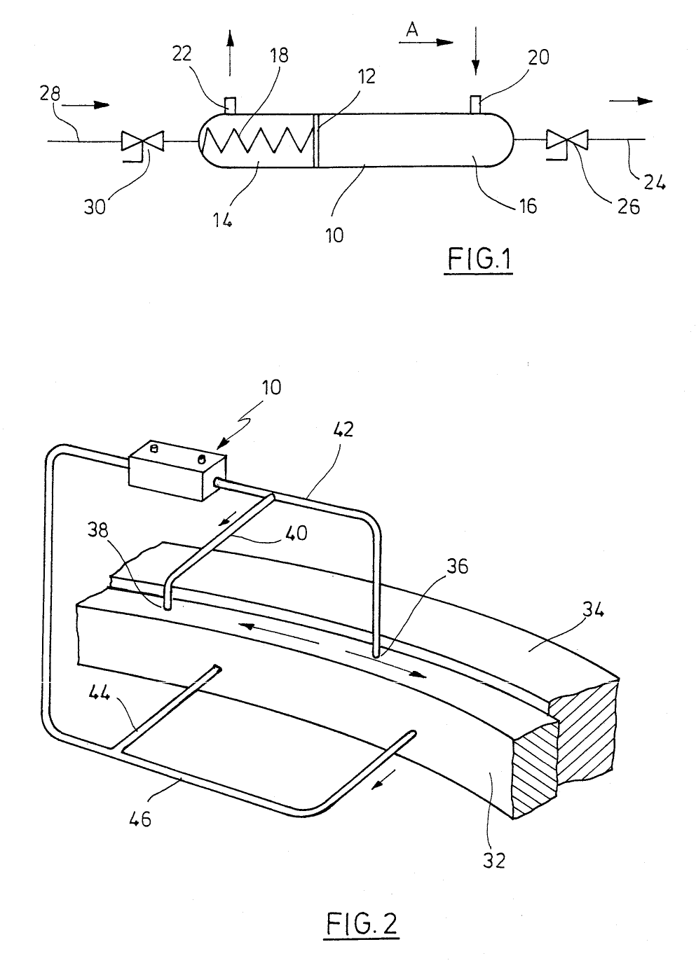

A container 10 for lubricant (not shown) is depicted in FIG. 1. The container 10 is subdivided into two chambers 14 and 16 by a movable piston 12. The piston 12 is pretensioned into the direction A by a spring 18. In the end portions of the container 10, two closable openings 20 and 22 are provided, wherein used lubricant is let out via the opening 22 and fresh lubricant is supplied via the opening 20. Further, the chamber portion 16 for fresh lubricant is connected to the roller bearing via a line 24. The line 24 is provided with a stop valve 26, which permits to stop the lubricant flow completely.

Via a line 28, the used lubricant is supplied in the chamber portion 14. Line 28 can be closed via a stop valve 30.

FIG. 2 shows the cut-out of a roller bearing with inner ring 32 and outer ring 34 in a schematic view. Distributed across the inner ring 32, plural inlets 36, 38 for lubricant are provided. Fresh lubricant is supplied to the inlets 36, 38 via a line 40, 42. The lubricant supplied to the roller bearing spreads about the raceway and via lubricant channels (not depicted), it flows out again on the inner ring 23 via lines 44, 46. The lines 44, 46 are combined and run out into the lubricant container 10. Besides to the depicted lubrification via the inner ring, lubrification via the outer ring 34 may also take place.

In the operation, the lubricant container 10 is filled with lubricant. Via the spring 18, the piston 12 is pretensioned into the direction A, so that the fresh lubricant from the chamber portion 16 is pressed into the line 24 when the stop valve 26 is opened. At the same time, the moving piston in the chamber portion 14 aspirates used lubricant via the line 28, when the stop valve 30 is opened. Altogether, the apparatus according to the present invention provides a compact lubricant container, which is extremely free from maintenance works.

What is claimed is:

1. An apparatus for the lubrication of a roller bearing of a wind energy plant, with a container for lubricant having a chamber, which is divided into a chamber portion (16) for fresh lubricant and a chamber portion (14) for used lubricant through a movable piston (12), wherein each chamber portion (14, 16) is connected via a line (24, 28) to a lubricant channel passing through the roller bearing (32).

2. An apparatus according to claim 1, characterised in that the piston (12) in the chamber is pretensioned by a spring means (18) in order to reduce the volume of the chamber portion (16) for the fresh lubricant and to increase the volume of the chamber portion (18) for the used lubricant.

3. An apparatus according to claim 1, characterised in that the line from the chamber portion for fresh lubricants to the roller bearing is provided with a stop valve (26).

4. An apparatus according to claim 1, characterised in that the line from the roller bearing to the chamber portion for used lubricant is provided with a stop valve (30).

5. An apparatus according to claim 1, characterised in that an indicating means is provided on the container, which indicates the position of the piston.

6. An apparatus according to claim 1, characterised in that a pump for lubricant is provided in at least one of the lines between container and roller bearing.

7. An apparatus according to claim 1, characterised in that the container has a closable opening, which is arranged in the region of the chamber portion (16) for fresh lubricant, in order to connect the same with the surroundings at minimum volume of that chamber portion (16).

8. An apparatus according to claim 1, characterised in that the container has a closable opening (22), which is arranged in the region of the chamber portion for used lubricants, in order to connect the same with the surroundings at minimum volume of that chamber portion.

9. An apparatus according to claim 1, characterised in that the container (10) is connected to one or plural lines (40, 42, 44, 46), which are each one at a time connected to an opening of one or plural lubricant channels passing through the roller bearing.
